(19) United States
(12) Patent Application Publication
(10) Pub. No.: US 2026/0350453 A1
(43) Pub. Date: Nov. 5, 2026

(54) DIGITAL TWIN FOR QUANTUM CIRCUIT EXECUTION LEVERAGING SPARE QUBITS FOR REAL-TIME PHASE MONITORING AND ERROR CORRECTION

(71) Applicant: Dell Products L.P., Round Rock, TX (US)

(72) Inventors: Navjot Kaur Khaira, Manotick (CA); Tejinder Singh, Manotick (CA); Said Tabet, Austin, TX (US)

(21) Appl. No.: 19/189,217

(22) Filed: Apr. 24, 2025

(51) Int. Cl. G06N 10/70; G06N 10/20

(52) U.S. Cl. CPC G06N 10/70; G06N 10/20

(57) ABSTRACT

The technologies described herein are directed towards a digital twin system coupled to one or more spare (unused in the active quantum circuit) qubits for optimized quantum circuit execution to enhance real-time phase monitoring and error correction. The digital twin system, via the spare qubit or qubits, mirrors the real-time execution of quantum circuits, utilizing spare qubits to optimize resource utilization, to detect errors in phase shifts, and to implement adaptive corrections by evaluating the interaction between active and spare qubits. By using spare qubits, the digital twin replicates real-time quantum execution, tracking the integrity of quantum states through controlled phase shifts to identify phase shift errors and adaptively correct for phase shift deviations. Via the spare qubit or qubits, the real-time detection of phase shift deviations, monitoring of noise, and ensuring of quantum state integrity is performed without disrupting ongoing quantum operations.

### RELATED APPLICATIONS

The subject patent application is related to U.S. Patent Application No. ______, filed ______, entitled “REAL-TIME DIGITAL TWIN FOR AUTOMATED CALIBRATION OF QUANTUM SYSTEMS” (docket no. 142070.01/DELLP1528US), U.S. Patent Application No. ______, filed ______, entitled “DIGITAL TWIN FOR PREDICTIVE NOISE MANAGEMENT AND SUPPRESSION IN QUANTUM SYSTEMS” (docket no. 142071.01/DELLP1523US), and U.S. Patent Application No. ______ filed, ______, entitled “DIGITAL TWIN FOR QUANTUM ERROR DETECTION USING INTENTIONAL DELAY AND PHASE MANIPULATION IN SPARE QUBITS” (docket no. 142072.01/DELLP1524US), the entireties of which patent applications are hereby incorporated by reference herein.

### BACKGROUND

A significant challenge in quantum computing is in maintaining the coherence and integrity of qubit quantum states during operations. Phase shifts, noise, and decoherence can cause significant errors that degrade the performance of quantum systems and algorithms. Quantum computing machines can process n qubits to represent information in a superposition space of size 2″. In quantum computing, as a result of noise, quantum fluctuations and probabilistic behavior, extracting this quantum information is obtained via multiple executions and corresponding measurements, known as “shots,” which increase exponentially with the number of qubits.

### BRIEF DESCRIPTION OF THE DRAWINGS

The technology described herein is illustrated by way of example and not limited to the accompanying figures in which like reference numerals indicate similar elements and in which:

FIG. 1 is a block diagram representation of an example a hybrid classical-quantum system in which a digital twin system is deployed in a computing system coupled to a quantum processing unit, in accordance with various example embodiments and implementations of the subject disclosure.

FIG. 2 is a block diagram representation of an example a hybrid classical-quantum system in which tunable components are deployed in a dilution refrigerator before a qubit chain to adjust microwave signals directed towards the qubit chain, in accordance with various example embodiments and implementations of the subject disclosure.

FIGS. 3 and 4 depict an example hybrid classical-quantum system for controlling and sensing telemetry data, in accordance with various example embodiments and implementations of the subject disclosure.

FIG. 5 is a conceptual representation of a quantum computer including a dilution refrigerator with qubits and cryogenic tunable components operating at qubit temperatures, in accordance with various example embodiments and implementations of the subject disclosure.

FIG. 6 is a representation of arbitrary rotations induced on the Bloch sphere through precisely-shaped microwave pulses in which the phase of the microwave signal applied at the qubit's resonant frequency determines the angle of rotation on the XY-plane, in accordance with various example embodiments and implementations of the subject disclosure.

FIG. 7 is a flow diagram showing example operations related to state duplication and phase monitoring of a spare and active qubit, in accordance with various example embodiments and implementations of the subject disclosure.

FIG. 8 is a flow diagram showing example operations related to error detection based on phase difference between an active qubit and a spare qubit, in accordance with various example embodiments and implementations of the subject disclosure.

FIG. 9 is a flow diagram showing example operations related to error correction to obtain acceptable phase deviation between an active qubit and a spare qubit, in accordance with various example embodiments and implementations of the subject disclosure.

FIG. 10 is a flow diagram showing example operations related to applying phase shift to a spare qubit, and upon determining that phase deviation data relative to an active qubit exceeds a phase deviation error threshold, applying a corrective phase shift to the spare qubit, in accordance with various example embodiments and implementations of the subject disclosure.

FIG. 11 is a flow diagram showing example operations related to applying a controlled phase shift to a spare qubit, and evaluating measurement data to detect phase inconsistency data relative to an active qubit, in accordance with various example embodiments and implementations of the subject disclosure.

### DETAILED DESCRIPTION

The technology described herein is generally directed to leveraging spare (otherwise unused) qubits for optimized quantum circuit execution, to enhance real-time phase monitoring and error correction. A digital twin system operates on one or more spare qubits to mirror the real-time execution of quantum circuits, dynamically utilizing one or more spare qubits to optimize resource utilization, to detect errors in phase shifts, and to implement adaptive corrections.

In one implementation, adaptive corrections are made via reinforcement learning (RL) models. The digital twin system can integrate predictive artificial intelligence (AI) models such as long short-term memory (LSTM) and/or gated recurrent units (GRU) to forecast phase errors and proactively adjust quantum operations, reducing the need for additional repetitive quantum shots that otherwise increase computational complexity, resulting in improved overall computational efficiency.

Note that as quantum computing continues to evolve, the inherent challenges of phase shifts, decoherence, and noise-induced errors remain problematic. Current quantum systems lack efficient real-time mechanisms to detect, predict, and/or correct these errors before they propagate. Described herein is the use of spare qubits to enhance system monitoring and error detection, in the form of a spare qubit corresponding to a digital twin system that can replicate and optimize quantum circuit execution while continuously monitoring quantum states for real-time phase shifts and errors, ensuring more stable and accurate quantum computation.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

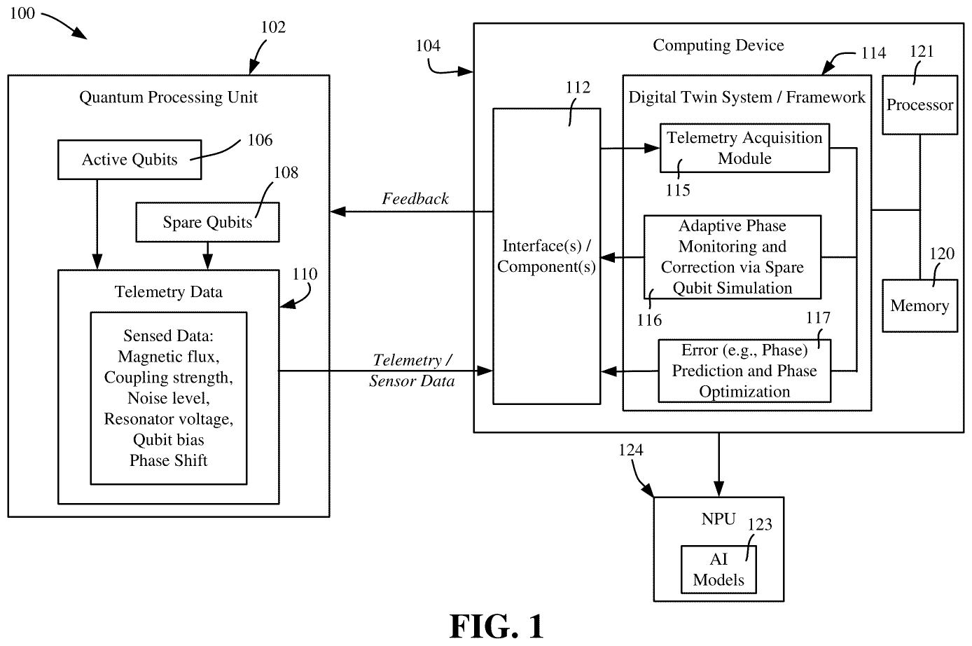

FIG. 1 is a representation of an example system 100 including a quantum processing unit 102 coupled to a computing device 104 such as a classical computer (wherein in general, classical computer refers to a commercially available, non-quantum computer system, e.g., server or server cluster). In general, the quantum processing unit 102 includes one or more active qubits 106 (e.g., quantum gates, qubit state setting and the like) and one or more spare qubits 108. Active qubits are those that are used for executing a quantum process, whereas spare qubits are those that are otherwise unused for in the execution of the quantum process. Note that typically a quantum computer has many qubits, many of which are spare qubits.

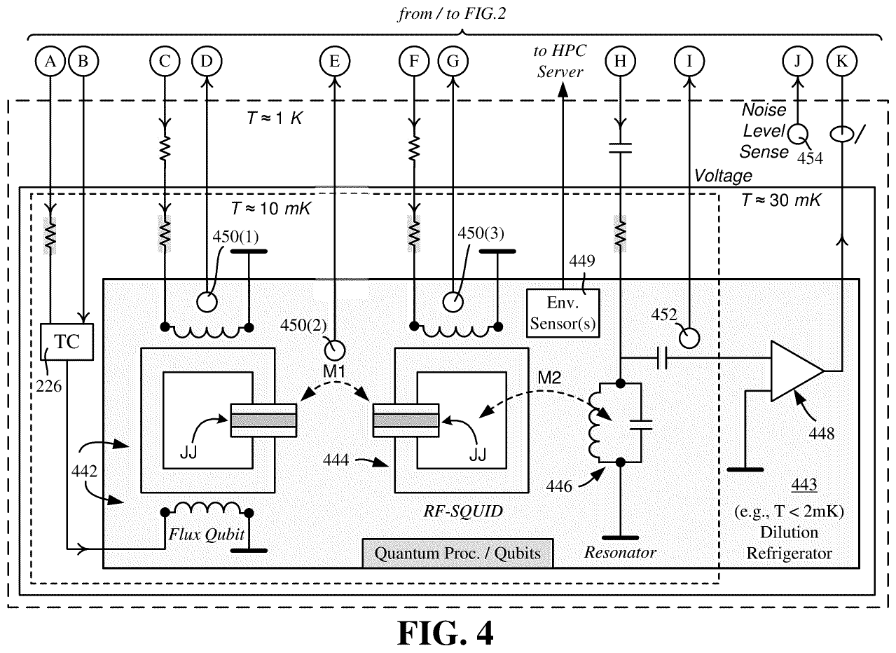

Sensors such as one or more radio frequency superconducting quantum interference device (rf-SQUIDs), temperature sensor(s), noise sensor(s) and so on gather telemetry data 110 related to the quantum processing unit 102. The sensed telemetry data 110 can include, but is not limited to, magnetic flux data, coupling strength data, noise level data, resonator voltage data, qubit bias data, and/or temperature data. The telemetry data 110 is coupled to the computing device 104, e.g., through one or more suitable interfaces and/or components 112, such as an analog-to-digital converter. Example telemetry data can include:
Magnetic flux at the qubit bias control. Monitoring magnetic flux helps maintain optimal qubit bias, for stable operation and accurate measurements. Real-time adjustments ensure the qubit remains within the desired operating range, reducing errors and improving coherence.
Mutual coupling strength between the qubit and the rf-SQUID. Accurate measurement of coupling strength is used for efficient qubit-resonator interactions; timely adjustment of coupling strength based on feedback enhances qubit readout precision.
The level of voltage at the output of the resonator/LC tank circuit. Maintaining the appropriate voltage level reduces signal distortion.
The noise level in the readout signal after it has been amplified. Real-time noise monitoring and adjustment lower the noise floor and improve the signal-to-noise ratio.
Temperature (env. sensor(s) block 449, FIG. 4), which can also sense humidity, electromatic radiation and so on), and/or microwave photons' power level can be sensed at each stage in the dilution refrigerator. Efficient use of resources, such as power and cooling, can be achieved through real-time adjustments, allowing for larger systems to be managed effectively.
A nalog voltage/current coupled to the rf-SQUID that determines whether the rf-SQUID operates in the hysteresis or non-hysteresis mode.
Phase shift-related data, for both active and spare qubits.

One example implementation of a digital twin system 114 (interchangeably referred to herein as a digital twin framework) is shown in FIG. 1, which includes functional modules 115-117. The digital twin system 114 can be loaded in a memory 120 and executed, at least in part, by a processor 121. Example functional modules can include, but are not limited to, a telemetry acquisition module 115 that continuously (or near-continuously) monitors and analyses quantum system data from sensors. AI models 123 on a neural processing unit (NPU) 124 analyze the telemetry to recommend adjustments, including to correct phase shift based on the deviation from the spare qubit's phase shift measurement data. Adaptive phase monitoring and correction via qubit simulation can be implemented in a module 116 (which can include processes in the AI models 123), to leverage the telemetry data to correct for phase shift deviation in the system. Based on the telemetry data and other information such as historical telemetry data, an error (e.g., phase) prediction and phase optimization module 118 operates as an AI/ML model to proactively determine errors before they occur and apply phase shift correction.

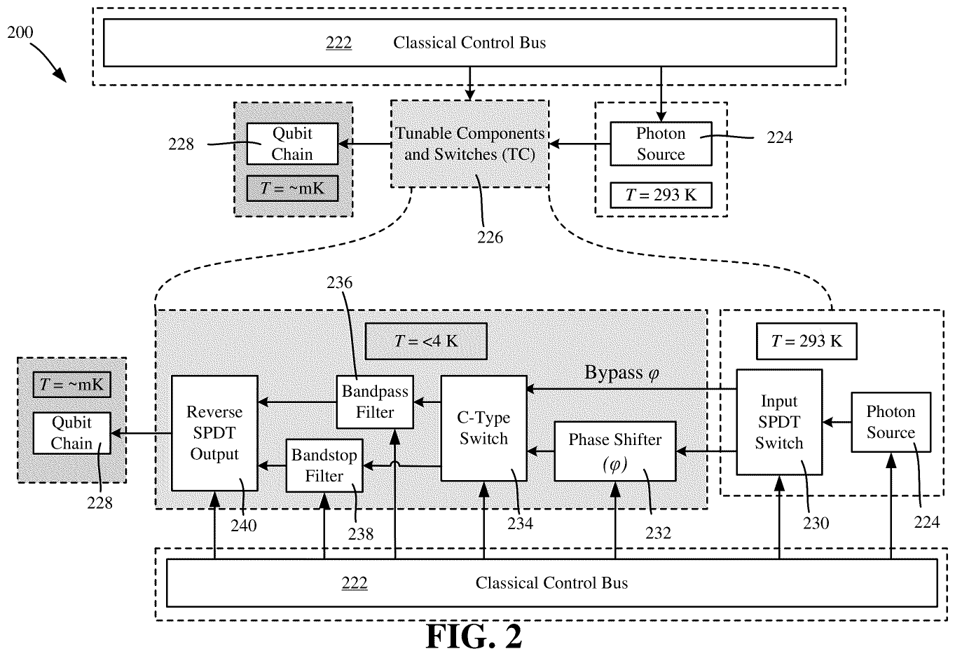

Turning to one example usage scenario, FIG. 2 is a generalized representation of an example hybrid classical-quantum system 200 that includes a classical control bus 222 (coupled to a classical computing device, e.g., 104, FIG. 1) and a quantum circuit in which a photon source 224, tunable components and switches (TC) 226 and qubit chain 228 interact with the benefit of intermediate tunable components 226 as described herein. Note that the tunable components 226 make the qubits less vulnerable to noise, thermal drift, or other forms of signal degradation; indeed, such signal issues can lead to errors in qubit manipulation, reducing gate fidelity. Feedback from the digital twin can tune the tunable components 226.

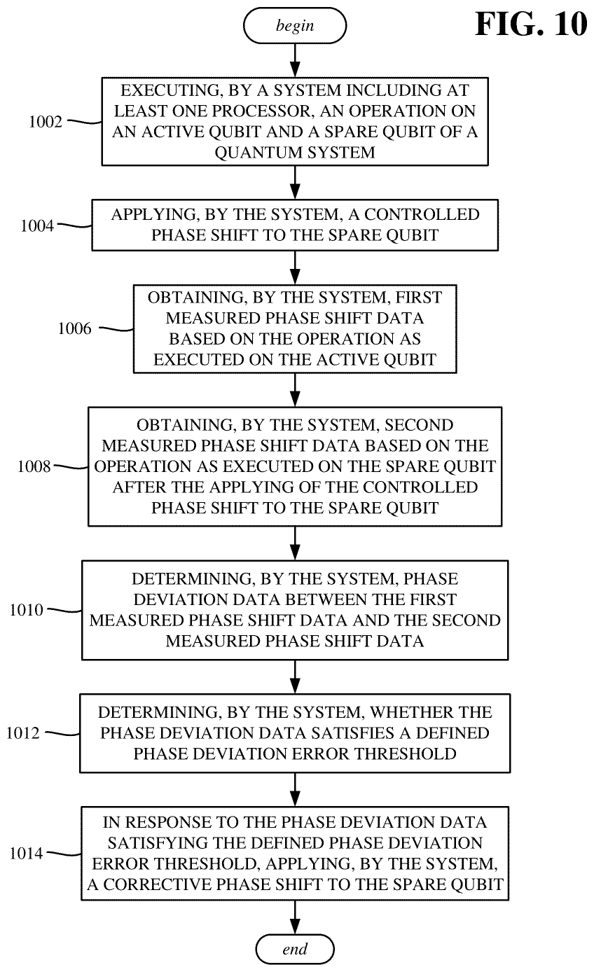

The photon source 224 generates the microwave signals used to manipulate qubits, as controlled by the computing device (the control bus 222 of which is shown in FIG. 10); the temperature at this stage is room temperature (e.g., around 293 K). The tunable components and switches 226 include an input single-pole, double throw (SPDT) switch 230 controlled via the classical control bus 222 to either bypass a phase shifter or shift the phase of the microwave signal via a phase shifter 232 that operates at cryogenic temperatures (below 4 K in this example). The phase shifter 232, if switched in, adjusts the phase of the microwave signals before they interact with the qubits of the qubit chain 228; the phase shifter may be a tunable device. The placement at cryogenic temperatures helps reduce phase drift caused by thermal noise. The phase shifter, which can alternatively be deployed at higher temperatures, can apply corrected phase shift to an active qubit, with the resulting quantum state then replicated onto one or more spare qubits, by which phase shift deviation can be determined.

A controlled C-type switch 234 selects a tunable (via the control bus 222) bandpass filter 236 and/or a bandstop filter 238. A reverse SPDT switch 230 couples the filtered signal to the qubit chain 228.

The qubit chain 228 includes qubits that are maintained at extremely low temperatures (millikelvin range) to ensure their stability/coherence during quantum gate operations. The signals from the photon source 224 interact directly with the qubits, manipulating their quantum states. After interacting with the qubits, the signal can be amplified, and measured (e.g., at room temperature); the amplified and measured signals are processed at room temperature by the classical computing device, such as to adjust the phase shifter and/or filtering to correct for phase noise, frequency noise, and so on to maintain qubit coherence.

In general, the integration of the classical computing device (control node) 104, including the digital twin system 114 (FIG. 1) can monitor the signals in real time, to detect any noise errors or deviations that arise due to external environmental factors or hardware imperfections. Because quantum gate operations are extremely sensitive to such noise-related variations, the classical computing device compares the incoming signals as measured and flags any discrepancies from what the signal should be without noise errors or the like. Upon detecting deviations, the control node dynamically adjusts the tunable components to correct the next signal before it interacts with the qubit chain, thereby minimizing the impact of noise on qubit operations.

Note that temperature control can be a significant part of the quantum portion of the system, as different components operate at significantly different temperature levels to minimize noise and maintain coherence. The quantum processor operates at extremely low temperatures, with the qubit chain at 10 mK or below, and the signal amplifier at 30 mK. These temperatures maintain superconductivity and prevent thermal noise from disrupting the delicate quantum states. The flux sensing and control lines that interact with the qubits are also cooled down to 1 K to ensure minimal noise and stable control of the quantum operations. The classical control components, such as the microwave photon source, SMU, ADC, DAC, and HPC cluster, operate at room temperature (around 293 K). These components handle the classical data processing and control signals that drive the quantum system.

Via the tunable signal control and classical monitoring feedback loop, the system effectively mitigates some of the noise, ensuring that the signals interacting with the qubits are phase-aligned and coherent throughout the gate operations. In some implementations, the tunable filter components 226 (FIG. 2) are located at cryogenic temperatures; the cryogenic placement of the tunable components 226 minimizes thermal noise and drift, further enhancing the system's ability to maintain coherence. The combination of real-time control and error monitoring by the classical node 104/digital twin system 114 ensures that qubits remain stable during computation, resulting in higher-fidelity quantum gate operations and improved overall performance of the quantum system. The technology described herein thus overcomes a significant challenge in quantum computing, namely preserving qubit coherence and reducing errors during quantum operations.

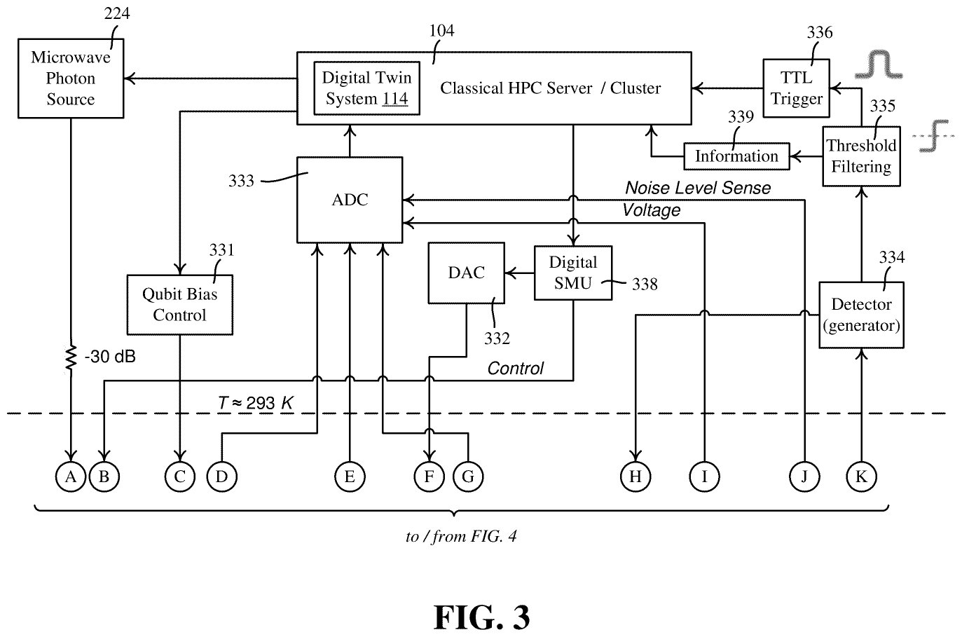

FIGS. 3 and 4 comprise a block diagram representation of an example quantum processor measurement and control setup/environment, in which qubit control and readout is facilitated by integrating a classical high-performance computing server/cluster 104 and the digital twin system (FIG. 1) with a quantum computing system having a quantum processor and qubits 442 (FIG. 4) near the base plate of a dilution refrigerator 443, on the order of 2 milli-Kelvin (mk).

The representation of FIG. 4 thus shows an example architecture of a quantum system with a focus on cryogenic control and signal processing. The overall system 200 (e.g., summarized in FIG. 2) integrates classical control components (FIG. 3) and quantum hardware (FIG. 4) to ensure the proper manipulation and measurement of qubits, with an emphasis on temperature management to maintain the coherence of quantum operations. As generally shown in FIG. 4, the quantum hardware is housed within the dilution refrigerator 443, ensuring ultra-low temperatures for stable qubit operations. In one implementation, the quantum portion (FIG. 4) of the hybrid system 200 (FIG. 2) operates with a combination of flux qubits, RF-SQUIDs (radio frequency-superconducting quantum interference devices), and a resonator, each contributing to the manipulation and control of quantum states.

In general, a flux qubit is a type of qubit that operates based on superconducting loops in which the current can circulate in both clockwise and counterclockwise directions, representing quantum superposition. The qubit (e.g., 442) is housed at a temperature of 10 mK or below (e.g., 2-4 mK), which helps maintain coherences and prevent decoherence due to thermal noise.

The RF-SQUIDs are superconducting circuits used to control the coupling between qubits. The RF-SQUIDs allow manipulation of quantum states by providing a tunable inductive coupling between the qubits. The Josephson junctions (JJ) in the RF-SQUIDs enable quantum tunneling, which is a core part of quantum operations in superconducting qubits. The magnetic interaction between the RF-SQUIDs (represented by M1), and between the RF-SQUID 444 and the resonator 446 (represented by M2), can adjust the energy levels and state transitions of the qubits.

The resonator 446 is coupled to the qubits, providing a device to read out the qubit states. By measuring the resonance frequency shifts, the state of the qubits can be inferred, allowing for quantum state measurements. After interacting with the qubits, the signal is passed through a cryogenic amplifier 448, e.g., operating at around 30 mK. Amplifying the signal in such a low-temperature environment ensures that noise is kept to a minimum before the signal is sent for classical processing. The amplifier 448 helps to boost the weak quantum signals for subsequent measurement without introducing significant noise that could affect accuracy.

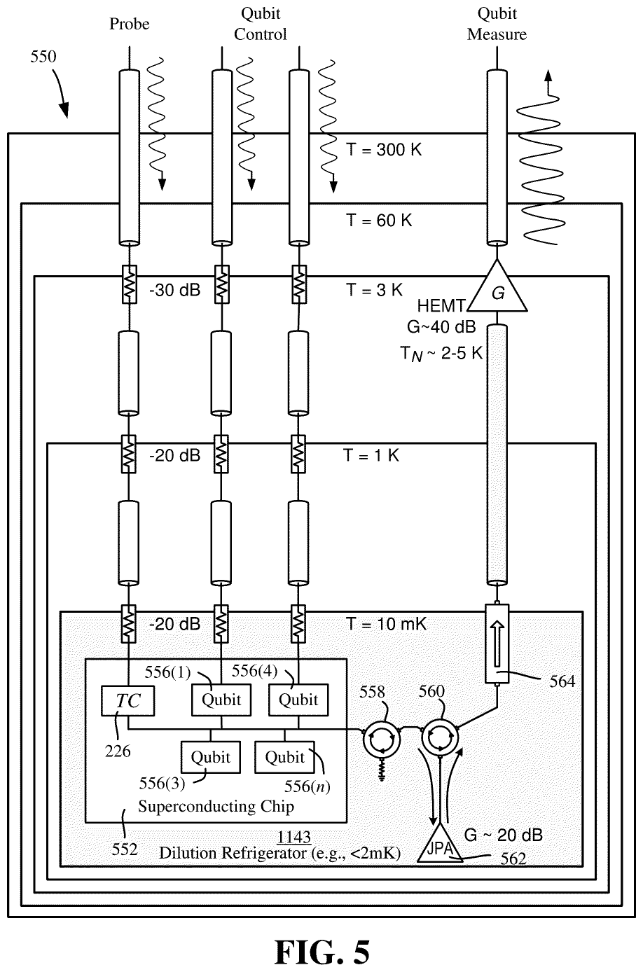

FIG. 4 also shows flux/coupling strength sensors 450(1)-450(3) and a voltage sensor 452. The environmental sensors 449 are shown in FIG. 4 as being in the dilution refrigerator 443, but it is understood that the environmental sensors 449 can be deployed at various temperature stages of the quantum system (e.g., such stages are shown in FIG. 5).

As shown in FIG. 3, the example classical (non-quantum) portion of the hybrid system 200 (FIG. 2) includes the microwave photon source 224, which is controlled by the classical high-performance compute (HPC) server/cluster 104, both operating at room temperature (around 293 K). As described herein, the classical system portion interfaces with the quantum hardware to drive, control, and measure qubit operations. M ore particularly and as will be understood, the digital twin system 114 in the server/cluster 104 processes the data from the quantum hardware, including measurements from the qubits, and can also provide real-time feedback for qubit control, adjusting the parameters, including the tunable components 226, based on the measured outcomes to optimize the quantum operations.

The microwave photon source 224 generates microwave signals that interact with the qubits. The microwave source 224 feeds microwave signals through coaxial cables into the quantum hardware. The microwave signals are controlled to ensure precise phase, amplitude, and timing, as is appropriate for quantum gate operations. The microwave photons from the microwave photon source 226 go through multiple temperature stages to reach the flux qubits (e.g., 442) in the dilution refrigerator 443.

At each stage, along with the reducing temperature, the microwave signal is heavily attenuated as qubits are provided very low-power microwave photons. Note that the HPC server/cluster 104 can control operation of the photon source 224 in terms of pulses, e.g., the sequence of pulses, the width and voltage of the pulses and the like can be controlled by the classical server/cluster 104; any amount of gates can be applied to the qubit, to control the qubit and configure the qubit, including as described herein.

A qubit bias control component (block 331, FIG. 3) provides precise magnetic flux control to the qubits. Adjusting the magnetic flux through the superconducting loops enables the fine-tuning of the qubit states. This control system operates at room temperature but communicates with the cryogenic quantum hardware through superconducting lines. The qubit bias control can be in the form of a constant voltage or current to adjust the energy levels of the qubit, and can be provided from the digital twin system 114 in the server/cluster 104. A change in the magnetic flux in the qubit 442 (FIG. 4, after absorption of a photon) induces a change in the mutual flux coupling (M1) with an RF-SQUID M2, which in general acts as a detector controlled by the digital twin system 114 in the server/cluster 104, e.g., via a digital-to-analog converter (DAC) 332. The RF-SQUID 444 includes a superconducting loop across a Josephson Junction (JJ) characterized by its critical current (IC), capacitance (C), and shunt resistance (R).

Note that in general, the digital-to-analog converter 332 along with an analog-to-digital converter (ADC) 333 translates between the digital signals used for classical computation and the analog signals used in the quantum hardware. The DAC 332 generates precise analog control signals for driving qubit operations, while the ADC 333 digitizes the analog signals received from the qubit measurement. These converters operate at room temperature in this example.

To register signals in RF-SQUIDs, a readout resonator/LC (inductor-capacitor) tank circuit 446 (FIG. 4) is used, including an inductor (L_{T}) and a capacitor (C_{T}), which together oscillate at a natural frequency ω_{T}/2 π=½π/\sqrt{(L_{T}C_{T})}. The resonator 446 is designed to be sensitive to small changes in magnetic flux, mutually coupled (M2) to the RF-SQUID 444, as appropriate for detecting photon interactions with the qubit. An external pumping current I_{rf} sin(ω_{P}t) is provided (via labeled circle “G”) from a detector/generator 334 (FIG. 3) at frequency Ω/2π, which is very close to the natural frequency of the LC tank circuit resonator 1296 (ω_{P}-ω_{T})/ω_{T}<<1 and quality factor Q>>1. The current/voltage bias to the RF-SQUID 444 is very accurate so as not to (inadvertently) operate the RF-SQUID's M2 in non-hysteresis mode.

Note that FIG. 4 only shows components for two RF-SQUIDS/qubits, however any practical number may be present in a given quantum computing configuration. Further note that the resonator 446 can obtain a control signal, and because any voltage generates the magnetic flux, a qubit state change will occur, as the generated magnetic flux will break the entanglement, or it will collapse the qubit; the system can read that what was the recent data, such as how much frequency changed in the resonator 446.

The output from the LC tank/resonator 446 is very weak, and hence is amplified (signal amplifier 448) and provided to the detector 334 (FIG. 3), which further performs threshold filtering (block 335) to quantize the state of the qubit, and provides the transistor-transistor logic (TTL) trigger (block 336) to the classical server/cluster 104. In general, threshold filtering component, block 335, along with the detector 334, are part of the classical control system and fed to the PCIe interface, and are responsible for analyzing the output from the quantum hardware. The signals are passed through the threshold filter 335 to remove noise and isolate the meaningful quantum information. The detector 334 then extracts the final measurement results from the filtered signals. The TTL trigger 336 is used for synchronizing operations within the classical system and with the quantum hardware. Precise timing of signals is used in quantum systems, and the TTL trigger 336 ensures that operations such as qubit state initialization, manipulation, and readout are synchronized.

To ensure accurate control, a PCIe card interface-based digital source measure unit (SMU) 338 can be used, such as a high-performance SM U that is commercially available. In general, a digital source measure unit (SMU) 338 provides precise voltage or current control for various elements in the quantum system. The SM U 338 ensures that bias voltages and other control parameters are stable, which maintains qubit fidelity. A high-performance PXI-based SMU (PCI eX tensions for Instrumentation) provides fast, precise dynamic measurements from DC to a 20 μs pulse, with outputs up to 210 V/315 mA, 10 femtoampere (fA) resolution, and the lowest source noise.

Similarly, a commercially available PXI-based digital-to-analog converter (DAC) 332 can be used, such as one that features sixteen simultaneous channels capable of supplying stimulus waveforms with output voltages ranging from OV to +30V, and output currents from 0 mA to +20 mA. In one implementation, both the SM U 338 and DAC 332 are compatible with PCIe interfaces and can be housed in a PXI chassis, which saves rack space and reduces maintenance cost. Also shown in FIG. 3 is the analog-to-digital converter (ADC) 333 coupled to the classical server/cluster 104 and to a number of sensors (450(1)-450(3), 452 and 454, the small circles at various tap points in FIG. 4, corresponding to the circled labels D, E, G, I and J).

To summarize, in one example implementation, the digital SM U 338 can control tunable components 226 (FIGS. 2-4) that can apply an adjusted microwave signal to a qubit. Feedback information (block 339, FIG. 3) can be provided to the classical digital twin system 114 of the server/cluster 104. Such feedback information allows real-time tuning and repeated measurements to ensure accurate quantum state tracking and error correction, e.g., if small deviations are detected between the applied signal and the measured signal following execution of one or more operations on the qubit as described herein, the signal can be adjusted and the operations reattempted and remeasured.

Thus, as generally represented in FIG. 3, hardware for control and readout can, for example, include one or more advanced source measure units (SMUs) and analog-to-digital converters (ADCs), which can be managed more efficiently with classical systems, thereby reducing the number of physical components and vendor equipment otherwise needed. Such a hybrid system can be designed modularly, where each module, including multiple qubits and their respective control/readout lines, can be independently managed by one or more classical processors. Such modularity simplifies system scaling, allowing new modules to be added without redesigning the entire control infrastructure.

The technology described herein leverages the precise classical control of the qubit control and measurement operations. For example, a classical high-performance computing server (or cluster of such servers) with peripheral component interconnect express (PCIe-based) or the like control can use a source measure unit (SMU) for quantum computers with some practical number (e.g., one the order of dozens) of qubits, including to apply controlled phase shift, controlled bandpass filtering, and controlled rotation to a qubit.

Further, the technology described herein controls the qubit readout circuit using a source measure unit and digital-to-analog converter; this can provide ultra-precise control of readouts with ultra-low signals. The hybrid classical-quantum technology described herein is, in part, directed to recording a photon-induced transition in a flux qubit, for example. Note however that photons/flux qubits are only examples, as indeed, the technology described herein is agnostic to any particular type of qubit, and further, that probe signals other than those based on microwave photons can be used, as appropriate for a given type of qubit.

Further, in one or more example implementations, one or more of the tunable components 226 can be designed and monolithically integrated with a superconducting chip that integrates the qubits. FIG. 5 is a block diagram representation of an example quantum processor measurement and control setup/system 550 including a measurement and control setup for a superconducting quantum computing chip 552 near the base plate of a dilution refrigerator 553, on the order of 2-10 Kelvin (mK). Some number of qubits 556(1)-556(n) (four are depicted, but any practical number may be present) are fabricated on the superconducting quantum computing chip 552, along with a monolithically integrated set of the tunable components 226. Note that one or all of the other tunable components 226 (FIG. 2, including the phase shifter 232, the bandpass filter 236 and/or bandstop filter 238) also can be similarly fabricated on the superconducting quantum computing chip 552.

A Iso shown in FIG. 5 as part of the qubit measuring portion are circulators 558 and 560, a Josephson parametric amplifier (JPA) 562, an isolator 564 and a high electron mobility transistor (HEMT) G. In general, a probe signal that is a set of strongly attenuated microwave tones (<-120 dBm) is by injected via coaxial cables (depicted as unshaded cylinders) and attenuators to the qubits 556(1)-556(n) through the various levels of the quantum processor system 550, resulting in a measurement signal being input via a readout line to a first port of the circulator 558. As described herein, the circulator 558 is configured for clockwise rotation, whereby the signal is routed to a second port (low insertion loss) and not the third port (high isolation, and coupled via resistor to ground), nor returned to the first port (low return loss). The second port is coupled to the input port of a second circulator 560 configured for counterclockwise rotation, such that the signal is routed to at least one Josephson parametric amplifier (JPA) 562, with the amplified measurement signal routed back to the output port of the circulator 560 though the isolator 564 to the HEMT G for further gain before measurement by one or more conventional RF devices (not explicitly shown). Note that the shaded cylinder shown in the measurement signal output path represents a superconducting coaxial cable. Based on the measurement results, qubit control signals can be sent to the qubits 556(1)-556(n).

Thus, each circulator is a nonreciprocal three-port device that allows signals to travel in only one predetermined direction among its three ports, whereby the qubit readout line uses such circulators 558 and 560 to provide isolation between different components so as to maintain the fidelity of the qubit readout. By isolating different parts of the readout circuit, circulators help in reducing noise that could otherwise affect the qubit's state and/or the accuracy of the readout. Multiple circulators are used in the quantum computing setup, ensuring that signals are correctly channeled to the appropriate destinations as shown in FIG. 5.

To summarize FIG. 5, the state of the superconducting qubits is probed, and the readout involves amplifying and delivering the measured result back to room temperature. The weak output signal from a qubit is amplified using one or more superconducting parametric amplifiers, such as Josephson parametric amplifiers (JPA), operating at 10 mK and semiconductor high electron mobility transistor (HEMT) amplifiers operating at 4K. The RF circulators are used to protect the quantum circuit from reflections and noise; the probing, control, and readout of qubit systems involves a large amount of microwave hardware.

Turning to operations of the digital twin system 114, as shown in FIGS. 1, 3 and 4, in general, as described herein the digital twin system 114 focuses on simulating the dynamics of qubits by evaluating the interaction between active and spare qubits, to enhance error detection and state integrity. By using spare qubits, the digital twin system 114 replicates real-time quantum execution, tracking the integrity of quantum states through controlled phase shifts. This use of spare qubits combined with continuous phase monitoring allows the system to validate quantum algorithm behavior and detect deviations in real time. This includes optimizing resource utilization by making use of otherwise idle qubits and identifying phase shift errors. The digital twin also allows for phase deviations to be detected and corrected dynamically.

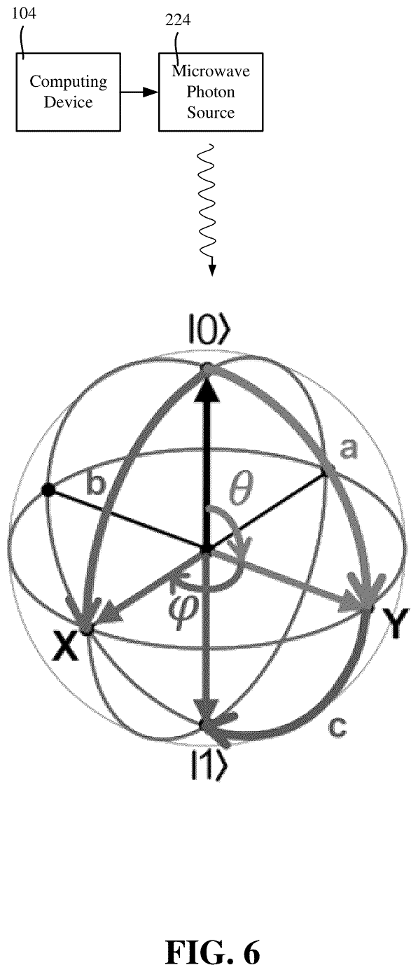

One suitable model is the quantum state model, in which each qubit is represented as a vector in the Bloch sphere (FIG. 6), particularly for single qubits. A computing device controls the microwave photon source 224 to apply a microwave signal to the qubit. Each qubit is associated with probabilities corresponding to its states, such as |0>, |1>, or superpositions of these states. Note that while generally single-qubit systems are described herein, the same principles can be extended to multi-qubit systems, which accounts for entanglement between qubits affecting their collective state.

With a digital twin, spare qubits are dynamically duplicated from the active qubits, mirroring their operations, including quantum gates and rotations. Additionally, the digital twin introduces measurement axes along X, Y, and Z to comprehensively evaluate quantum states from different perspectives. This data is then used to verify state integrity and detect any phase deviations. For error detection and correction, the model identifies any deviations in phase shifts by comparing the known phase values with the measured values from the system. These deviations are classified by the model, to distinguish between errors caused by noise in the system and those caused by quantum state degradation, facilitating real-time corrections. In one implementation, the digital twin integrates AI for predictive error detection and mitigation. By integrating AI models, the digital twin can predict potential errors based on real-time data from phase-shifts and quantum measurements, enabling adaptive and predictive corrections to maintain high fidelity.

Described herein is a mathematical model for a digital twin. With respect to quantum state representation, a qubit Q is represented as a state vector |ψ [symbol] α|0 [symbol] +β|1 [symbol] , where |α|²+|β|²=1. Spare qubits Qₛ are assigned the same state as the active qubit. If |ψ_{α} [symbol] is the active qubit state, then:

|ψₛ [symbol] =|ψα [symbol] .

For phase shift representation, a phase shift of φ is applied to a qubit Qₛ shown by the phase shift operator:

$${U}_{ϕ} = ( \begin{matrix}1 & 0 \\ 0 & {e}^{i ϕ}\end{matrix} ) .$$

Phase φ can be dynamically adjusted by classical control described herein with reference to FIGS. 1-4.

Turning to an example process for state duplication and phase monitoring, process input is based on a quantum system with N active qubits Qₐ[i], and M spare qubits; Qₛ[i], i denotes the qubit index. phase shift φₛ[i]. The process output is real-time phase comparison for state integrity verification.

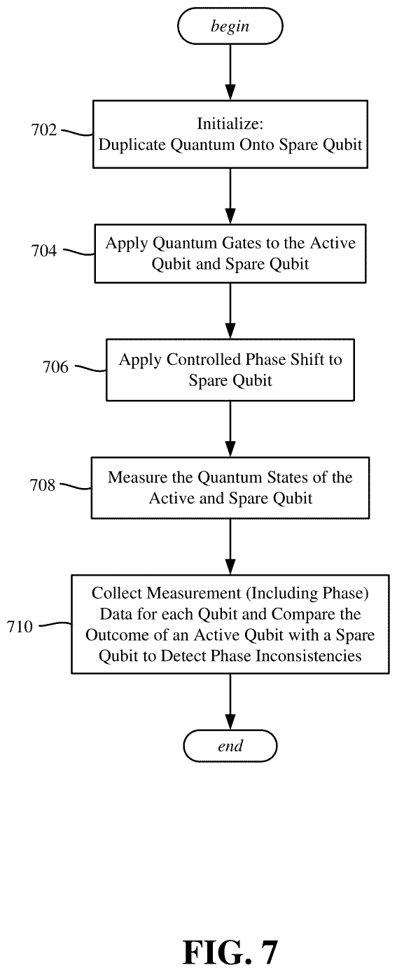

The process, shown FIG. 7, includes an initialization operation in which the quantum state of each active qubit Qₐ[i] is represented by the following state vector:

|ψₐ[i]=aᵢ|0 [symbol] +βᵢ|1 [symbol] , where |αᵢ|²+|βᵢ|²=1.

At operation 702, this quantum state is duplicated onto the spare qubit, (or replicated onto multiple spare qubits):

|ψₛ[i] [symbol] =|ψₐ[i] [symbol] =αᵢ|0 [symbol] +βᵢ|1 [symbol] .

The state duplication ensures that the spare qubit is a direct copy of the active qubit's quantum state. Note that for purposes of explanation, a single spare qubit is described, although it is understood that there can be multiple spare qubits involved in the process of FIG. 7. Mathematically, the digital twin performs this duplication by setting the initial state vector of Qₛ[i] equal to that of Qₐ[i].

In an apply operation shown in operation 704, quantum gates are applied to both the active qubit Qₐ[i] and spare qubit Qₛ[i]. For example, consider the application of a Hadamard gate H to a qubit. The Hadamard gate's unitary matrix is:

$$H = \frac{1}{\sqrt{2}} ( \begin{matrix}1 & 1 \\ 1 & - 1\end{matrix} ) .$$

When this gate is applied to an active qubit |ψₐ[i] [symbol] , the new state is:

$$\vert {ψ}_{a}^{′} [ i ] = H \vert {ψ}_{a} [ i ] 〉 = \frac{1}{\sqrt{2}} ( \begin{matrix}1 & 1 \\ 1 & - 1\end{matrix} ) ( \begin{matrix}{α}_{i} \\ {β}_{i}\end{matrix} ) .$$

Upon simplifying:

$$\vert {ψ}_{a}^{′} [ i ] 〉 = \frac{1}{\sqrt{2}} ( ( {α}_{i} + {β}_{i} ) \vert 0 〉 + ( {α}_{i} - {β}_{i} ) \vert 1 〉 ) .$$

The same operation is applied to the corresponding spare qubit Qₛ[i]:

$$\vert {ψ}_{s}^{′} [ i ] 〉 = \frac{1}{\sqrt{2}} ( ( {α}_{i} + {β}_{i} ) \vert 0 〉 + ( {α}_{i} - {β}_{i} ) \vert 1 〉 ) .$$

This process ensures that the spare qubit undergoes the same transformations as the active qubit keeping their states identical unless a phase shift or noise is introduced.

A next operation, operation 706, introduces phase shift by applying controlled phase shifts to the spare qubit, as directed by the classical system. A phase shift of φₛ[i] applied to spare qubit Qₛ[i], is represented by the unitary operator:

$${U}_{{ϕ}_{s} [ i ]} = ( \begin{matrix}1 & 0 \\ 0 & {e}^{i {ϕ}_{s} [ i ]}\end{matrix} ) .$$

The state of the spare qubit after the phase shift is applied is:

$$\vert {{ψ}_{s} [ i ]}^{ϕ} 〉 = {U}_{{ϕ}_{s} [ i ]} \vert {ψ}_{s}^{′} [ i ] 〉 = ( \begin{matrix}1 & 0 \\ 0 & {e}^{i {ϕ}_{s} [ i ]}\end{matrix} ) ( \begin{matrix}{α}_{i}^{′} \\ {β}_{i}^{′}\end{matrix} ) .$$

This gives:

$$\vert {{ψ}_{s} [ i ]}^{ϕ} 〉 = {α}_{i}^{′} \vert 0 〉 + {β}_{i}^{′} {e}^{i {ϕ}_{s} [ i ]} \vert 1 〉 .$$

At this point, the phase shift φₛ[i] has been applied, which will be compared with the active qubit during phase monitoring as described herein.

Operation 708 represents performing the active and spare qubit measurement in multiple bases. To measure the quantum states of both the active and spare qubit, Pauli matrices are used as measurement operators for different axes (X, Y, Z). To measure in the Z-basis, the measurement operator is the Pauli-Z matrix is:

$${M}_{Z} = ( \begin{matrix}1 & 0 \\ 0 & - 1\end{matrix} ) .$$

The measurement outcome is the expectation value of M_{z} with respect to the quantum state |ψₛ[i] [symbol] given by:

$$〈 {M}_{Z} 〉 = 〈 {{ψ}_{s} [ i ]}^{ϕ} \vert {M}_{Z} \vert {{ψ}_{s} [ i ]}^{ϕ} 〉 = {\vert {α}_{i}^{′} \vert}^{2} - {\vert {β}_{i}^{′} {e}^{i {ϕ}_{s} [ i ]} \vert}^{2} .$$

Similarly, measurements can be taken along the X-basis and Y-basis using their respective Pauli matrices:

$$\begin{matrix}{M}_{X} = \frac{1}{\sqrt{2}} ( \begin{matrix}1 & 1 \\ 1 & - 1\end{matrix} ) \\ {M}_{Y} = \frac{1}{\sqrt{2}} ( \begin{matrix}1 & - i \\ i & - 1\end{matrix} ) .\end{matrix}$$

At operation 710, the system collects measurement data for each qubit and compares the outcomes of active qubits with spare qubits to detect phase inconsistencies. Operation X 12 represents returning the measured phase data for further error detection.

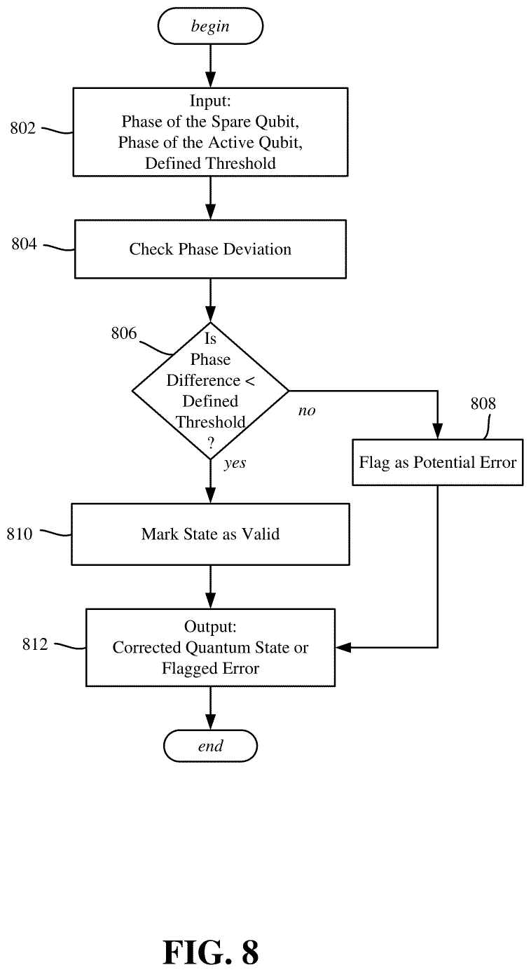

Turning to an example process (FIG. 8) for error detection and correction, an input to the process (block 802) is the phase of the spare qubit φₛ, the phase of active qubit φₐ, and a defined threshold δ_{threshold}. An output from the process (block 812) is the corrected quantum state or a flagged error.

Operation 804 represents checking phase deviation, in which the phase deviation between the active and spare qubits is calculated as the absolute difference between their phases:

Δφ[i]=|φₐ[i]−φₛ[i]|.

Error detection, operation 806, evaluates whether Δφ[i]>δ_{threshold}; if so, this is flagged as potential error at operation 808. Otherwise, the state is marked as valid at operation 810. The defined threshold δ_{threshold} is determined based on the system's tolerance to phase shifts, which can vary depending on the qubit coherence times and environmental noise.

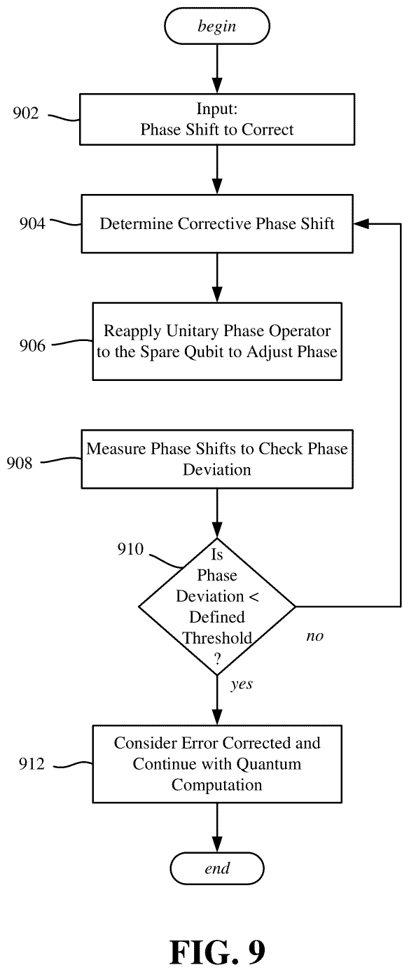

Error correction and phase adjustment are represented by the example operations of FIG. 9. If an error is detected, the system attempts via FIG. 9 to correct the phase of the spare qubit (block 902). At operation 904, the corrective phase shift φ_{corr}[i] is calculated using a feedback loop:

φ_{corr}[i]=φₛ[i]−αΔφ[i],

where α is a learning rate that controls the magnitude of the phase adjustment.

After calculating the corrective phase shift, at operation 906, the unitary phase operator is reapplied to the spare qubit:

$$\vert {{ψ}_{s} [ i ]}^{corr} 〉 = {U}_{{ϕ}_{corr} [ i ]} \vert {{ψ}_{s} [ i ]}^{ϕ} 〉 = {α}_{i}^{′} \vert 0 〉 + {β}_{i}^{′} {e}^{i {ϕ}_{corr} [ i ]} \vert 1 〉 .$$

The system then performs another round of measurements (operation 908) to verify that the corrected phase shift brings the phase deviation Δφ[i] below the threshold:

Δφ[i]^{new}=|φ_{α}[i]−φ_{corr}[i]|.

At evaluated at operation 910, if Δφ[i]^{new}<δ_{threshold}, the error is considered corrected, and the quantum computation continues.

If not, iterative correction continues by returning to operation 904 for iterative error minimization, which refers to the system possibly having to perform multiple iterations of phase correction until the error falls below the acceptable threshold. This iterative process can be written as:

$${ϕ}_{corr}^{( k + 1 )} [ i ] = {ϕ}_{corr}^{( k )} [ i ] - {α}_{k} Δ ϕ [ i ] ,$$

where k is the iteration number, and αₖ is a dynamic learning rate that may decrease with each iteration showing convergence. This feedback loop adjusts the phase shift and reruns the operations if errors are detected. This minimizes the number of shots needed to get accurate measurements. Note that the iterations can be halted if some stopping criterion is met (e.g., too many iterations, phase deviation not improving, and so on), with some action taken such as issuing an alert if phase correction is halted.

Turning to one implementation that uses an AI model for predictive error detection, the digital twin system 114 can incorporate an AI model to predict potential errors based on historical data. The AI model takes into account phase differences, correction patterns, and environmental factors. By recognizing trends and anomalies, the AI model can provide real-time suggestions for phase adjustments, minimizing error propagation.

Note that in the absence of AI, the digital twin system 114 can still simulate the quantum system, replicate the operations on spare qubits, and monitor phase shifts. However, the system would rely on predefined threshold checks and feedback loops to detect and correct errors; there would not be the predictive capacity to anticipate phase errors or intelligently adjust the system's behavior before a significant error occurs. This can lead to less efficient corrections and a higher number of quantum operations to maintain accuracy. By incorporating an AI model, the digital twin becomes more proactive and thereby generally more efficient.

A task of the AI model for predictive error detection and phase optimization is to predict and optimize phase shifts and detect errors based on system performance. Time-series data and phase evolution modeling are used, in which because each qubit's phase shift φ(t) evolves over time, this time evolution can be captured through time-series modeling. For each qubit Qᵢ, its phase shift at time t is tracked, represented as:

$${ϕ}_{i} ( t ) = {ϕ}_{i , 0} + {\int }_{0}^{t} {ω}_{i} ( {t}^{′} ) {dt}^{′} ,$$

based on φ_{i,0} being the initial phase of the qubit at t=0 and ωᵢ(t′) being the time-dependent angular frequency for qubit i.

The phase shifts φᵢ(t) are significant as they drift due to noise and errors, whereby predicted future values of φᵢ(t) are predicted based on past measurements. To model the phase shift evolution over time for the qubits in the system, the AI model uses:

[symbol]

(t+Δt)=f_{θ}(φᵢ(t),φᵢ(t−Δt), . . . ),
where f_{θ} is a recurrent neural network; (Long Short-Term memory LSTM or gated recurrent unit GRU can be used, for example). The predicted phase shift is [symbol] ; (t+Δt) at future time (t+Δt) given past phase measurements. The recurrent model captures the temporal dependencies between past and future phases.

With respect to phase shift error prediction, the error between the predicted phase [symbol] (t) and the actual measured phase φᵢ(t) is calculated as:

Δφᵢ(t)=| [symbol] (t)−φᵢ(t)|.

If Δφᵢ(t)>δ_{threshold}, Where δ_{threshold} is a predefined phase error tolerance, the system flags this as an error. The AI model then adjusts the predicted phase using:

[symbol]

(t)= [symbol] (t)−g(Δφᵢ(t),system state),
where g(·) is an adjustment function learned by the reinforcement learning (RL) model. The function determines how to optimally correct phase errors based on the system's current state.

Turning to reinforcement learning for phase shift adjustment, a reinforcement learning (RL) model operates based on a Markov decision process. In this process, at each time step t, the state Sₜ represents the quantum system's condition. The state Sₜ is defined as a combination of the system's relevant parameters including the phase shift φᵢ(t) for each qubit Qᵢ, the phase shift deviation Δφᵢ(t), and environmental parameters that could influence qubit performance, such as temperature or noise levels:

Sₜ={φᵢ(t),Δφᵢ(t),environmental parameters}

Based on this state, the reinforcement learning agent takes an action Aₜ. This action can be to adjust the phase shift φᵢ(t) of a qubit, or re-run certain quantum operations to correct potential errors. The objective of the reinforcement learning agent is to find the optimal sequence of actions that minimize phase shift errors.

The reward function Rₜ is used to guide the reinforcement learning agent's learning process. In this case, the reward function is negatively proportional to the square of the phase deviation Δφᵢ(t) at time t:

$${R}_{t} = - {\sum }_{i} {( {Δϕ}_{i} ( t ) )}^{2} .$$

This reward is negative, as it penalizes high phase errors. The reinforcement learning agent learns to maximize the cumulative reward over time, effectively minimizing phase errors through continuous feedback.

With respect to a training objective for predictive model, for the predictive phase shift model, the loss function is the mean squared error between the predicted phase [symbol] (t) and the actual phase φᵢ(t) of the qubits. The general objective is to minimize the error between the predicted and actual phase shifts for each qubit:

$$ℒ ( θ ) = \frac{1}{N} {\sum }_{i = 1}^{N} {( \text{?} ( t ) - {ϕ}_{i} ( t ) )}^{2} .$$

Here N is the number of qubits, θ are the learnable parameters of the predictive model.

By minimizing this loss function, the model learns to accurately predict future phase shifts based on past data and current system conditions, which are significant for the RL agent to make better decisions. For the RL model, the optimization problem involves finding an optimal policy that maximizes the expected cumulative reward:

$${max}_{θ} E [ {\sum }_{t = 0}^{∞} {γ}^{t} {R}_{t} ] ,$$

where γ is the discount factor, which controls how much future rewards are taken in account (with 0≤γ≤1), and Rₜ is the reward at time t. The RL agent updates its policy based on the policy gradient theorem, using a variant of the stochastic gradient descent algorithm to maximize the expected cumulative reward. The update rule for the policy parameters θ is given by:

θ←θ+ηE[∇θlog π_{θ}(Aₜ|Sₜ)Gₜ].

Here η is the learning rate, Gₜ is the cumulative reward (also called the return) at time t, which is the sum of future rewards:

$${G}_{t} = {\sum }_{{t}^{′} \geq t} {γ}^{{t}^{′} - t} {R}_{{t}^{′}}$$

This update rule adjusts the policy in the direction that maximizes future rewards based on the observed returns Gₜ.

In one example implementation framework for digital twin integration, a quantum simulation environment setup is used. To this end, the digital twin system can include a quantum circuit simulator, which tracks the evolution of qubit states through unitary transformations. For a set of n qubits, the state of the system is represented by a density matrix ρ, or by a state vector |ψ [symbol] if pure. The evolution of the quantum state is governed by the Schrodinger equation:

|ψ(t) [symbol] =U(t)|ψ(0) [symbol] ,

where U(t) is a unitary matrix representing the quantum gates applied at time t, and |ψ(0) [symbol] is the initial state.

For a quantum gate operation Gᵢ such as Hadamard H, CNOT, or Pauli-X, the quantum state evolves as:

|ψ′ [symbol] =Gᵢ|ψ [symbol] .

These operations can be simulated, which allows the full matrix-vector multiplication for each gate application.

With respect to noise modeling and decoherence calculations, quantum systems are inherently noisy, leading to decoherence. The digital twin system 114 can simulate quantum noise using K raus operators {Eₖ} that represent the system-environment interactions. The updated quantum state due to noise is given by:

$${ρ}^{′} = {\sum }_{k} {E}_{k} ρ {E}_{k}^{†} ,$$

where ρ is the current density matrix of the system, and Eₖ are the K raus operators modeling noise effects such as dephasing, depolarization, or amplitude damping.

For dephasing noise, the K raus operators E₀ and E₁ are defined as:

$${B}_{0} = ( \begin{matrix}1 & 0 \\ 0 & \sqrt{1 - p}\end{matrix} ) , {E}_{1} = ( \begin{matrix}0 & 0 \\ 0 & \sqrt{p}\end{matrix} )$$

where p is the probability of dephasing. In the digital twin, these noise models can be applied after every quantum gate to simulate realistic system performance.

The classical control layer manages the application of phase shifts and monitors quantum operations, including for phase correction. A control process computes the appropriate phase corrections based on the deviation Δφᵢ(t) calculated for each qubit. The correction formula is:

$${ϕ}_{i}^{new} = {ϕ}_{i} - {αΔϕ}_{i} ,$$

where α is a learning rate that controls the magnitude of the correction. This calculation can be performed in real-time on edge processors to ensure virtually immediate phase adjustments.

M ore particularly, with edge computing for real-time feedback, the phase adjustments and qubit measurements can be processed locally on edge computing devices, such as field-programmable gate arrays or specialized control processors. The edge device performs the phase correction (as described herein, based on Δφᵢ(t)), and gate fidelity computation, which calculates the fidelity of each quantum gate using the overlap of the ideal and actual quantum states:

F(G)= [symbol] ψ_{ideal}|ψ_{actual} [symbol] .

Edge devices collect phase shift data φᵢ(t), compute corrections, and apply them virtually instantly to the quantum hardware without the latency of cloud-based systems.

The AI models can be periodically retrained on cloud-based infrastructure, using data collected from quantum executions. The cloud runs batch updates for the LSTM/GRU model and reinforcement learning agent using the retraining operations. This includes data aggregation, which collects new time-series data from edge devices:

{φᵢ(t),Δφᵢ(t),system state}.

Batch gradient descent updates model weights θ using the backpropagation algorithm on the loss function [symbol] (θ);

θ←θ−η∇_{θ} [symbol] (θ),
where η is the learning rate.

Policy gradient update is for the reinforcement learning agent; thus, in the reinforcement learning model, the policy π_{θ}(Aₜ(Sₜ) is updated using the policy gradient method. The objective is to adjust the parameters θ to maximize the expected cumulative reward. The update rule for the policy parameters is based on the gradient of the expected reward:

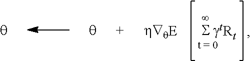

which can be given in a simplified version as described herein using the policy gradient theorem:

θ←θ+ηE[∇_{θ}log π_{θ}(Aₜ|Sₜ)Gₜ],
where Gₜ is the cumulative reward at time t, and γ is the discount factor. This update will allow the reinforcement learning agent to improve its decision-making over time by learning from the observed phase deviations and corrective actions.

To ensure the quantum digital twin operates effectively in real-time, a real-time monitoring and feedback system can be implemented. The real-time monitoring and feedback system tracks and displays quantum state fidelity, phase shift deviations and correction success rates metrics.

For quantum state fidelity: the fidelity F of quantum operations can be computed and visualized as:

F(ρ,σ)=(Tr(\sqrt{√ρσ√ρ}))/²,
where ρ is the simulated quantum state, and σ is the actual state. This metric provides a direct measure of how closely the real quantum state matches the expected outcome from the digital twin simulation.

For phase shift deviations, the system continuously (or near-continuously) monitors the phase shift deviations Δφᵢ(t) for the qubits in real-time, highlighting any phase errors and displaying corrective actions applied by the system. For correction success rates, the effectiveness of phase corrections can be measured by comparing the pre-correction and post-correction phase shift deviations, and this data can be visualized over time to track improvements in system performance.

One or more example implementation described herein can be embodied in a system. The system can include a quantum processing unit comprising an active qubit and a spare qubit, a computing device including at least one processor, and a digital twin framework configured to execute, at least in part, via the computing device. The digital twin framework is coupled to the quantum processing unit, and is configured to duplicate a first state of the active qubit to the spare qubit as the first state of the spare qubit, apply a duplicate set of one or more quantum gates to the active qubit and the spare qubit, to transform the first state of the active qubit to a second state of the active qubit, and to transform the first state of the spare qubit to the second state of the spare qubit, apply a controlled phase shift to the spare qubit to obtain a third state of the spare qubit, measure first current state data of the active qubit, measure second current state data of the spare qubit, and determine, based on the first current state data and the second current state data, whether phase deviation data between the active qubit and the spare qubit satisfies a defined error deviation threshold. The digital twin framework is configured to, in response to the phase deviation data satisfying the defined error deviation threshold, determine a corrective phase shift based on the phase deviation data, and apply the corrective phase shift to the spare qubit to obtain the third state of the spare qubit.

The corrective phase shift can be a first corrective phase shift, the phase deviation data can be first phase deviation data, and the digital twin framework can be further configured to after application of the first corrective phase shift, measure third current state data of the active qubit, measure fourth current state data of the spare qubit, and determine, based on the third current state data and the fourth current state data, whether second phase deviation data between the active qubit and the spare qubit satisfies the defined deviation error threshold. In response to the second phase deviation data satisfying the defined deviation error threshold, the digital twin framework can be configured to determine a second corrective phase shift based on the phase deviation data, and apply the second phase shift to the spare qubit to obtain a fourth state of the spare qubit.

The digital twin framework can be further configured to iteratively apply one or more corrective phase shifts to the spare qubit until one or more phase inconsistency data measurements, corresponding to the one or more corrective phase shifts, result in the phase inconsistency data satisfying the defined error difference threshold.

The telemetry data can include environmental data of an environment associated with the quantum processing unit, and wherein the digital twin framework can be further configured to simulate quantum noise associated with a quantum gate of the duplicate set of the one or more quantum gates.

The digital twin framework can be configured to invoke a prediction model set to predict a phase-related error associated with the quantum processing unit.

The noise prediction model set can include at least one of: a recurrent neural network, or a long short-term memory network based on the telemetry data and prior collected telemetry data.

The digital twin framework can be configured to invoke an adaptive correction model set to determine an amount of phase shift to apply as the corrective phase shift.

The adaptive decision-making model set can include a reinforcement learning model.

One or more example implementations and embodiments, such as corresponding to example operations of a method, can be represented in FIG. 10. Example operation 1002 represents executing, by a system comprising at least one processor, an operation on an active qubit and a spare qubit of a quantum system. Example operation 1004 represents applying, by the system, a controlled phase shift to the spare qubit. Example operation 1006 represents obtaining, by the system, first measured phase shift data based on the operation as executed on the active qubit. Example operation 1008 represents obtaining, by the system, second measured phase shift data based on the operation as executed on the spare qubit after the applying of the controlled phase shift to the spare qubit. Example operation 1010 represents determining, by the system, phase deviation data between the first measured phase shift data and the second measured phase shift data. Example operation 1012 represents determining, by the system, whether the phase deviation data satisfies a defined phase deviation error threshold. Example operation 1004 represents, in response to the phase deviation data satisfying the defined phase deviation error threshold, applying, by the system, a corrective phase shift to the spare qubit.

Further operations can include obtaining, by the system, environmental data associated with the quantum system, and simulating, by the system based on the environmental data, quantum noise in the quantum system.

Further operations can include obtaining, by the system, an amount of the corrective phase shift from a model set of the system based on the phase deviation data, prior phase deviation data from before the phase deviation data was obtained, and prior corrective phase shift data representative of previous corrective phase shifts from before the corrective phase shift.

Further operations can include obtaining, by the system, current telemetry data and prior telemetry data associated with the quantum system, and predicting, by a model set of the system based on the current telemetry data and prior telemetry data, at least one phase-related error with respect to the active qubit.

The operation can be a first operation, the phase deviation data can be first phase deviation data, the corrective phase shift can be a first corrective phase shift, and further operations can include, in response to the first phase deviation data not satisfying the defined phase deviation error threshold, determining, by the system, a second corrective phase shift based on the first phase deviation data, applying, by the system, the second corrective phase shift to the spare qubit, executing, by the system, a second operation on the active qubit and the spare qubit, obtaining, by the system, third measured phase shift data based on the second operation as executed on the active qubit, obtaining, by the system, fourth measured phase shift data based on the second operation as executed on the spare qubit after the applying of the controlled phase shift to the spare qubit, determining, by the system, second phase deviation data between the third measured phase shift data and the fourth measured phase shift data, determining, by the system, whether the second phase deviation data satisfies the defined phase deviation error threshold, and, in response to the second phase deviation data satisfying the defined phase deviation error threshold, applying, by the system, a second corrective phase shift to the spare qubit.

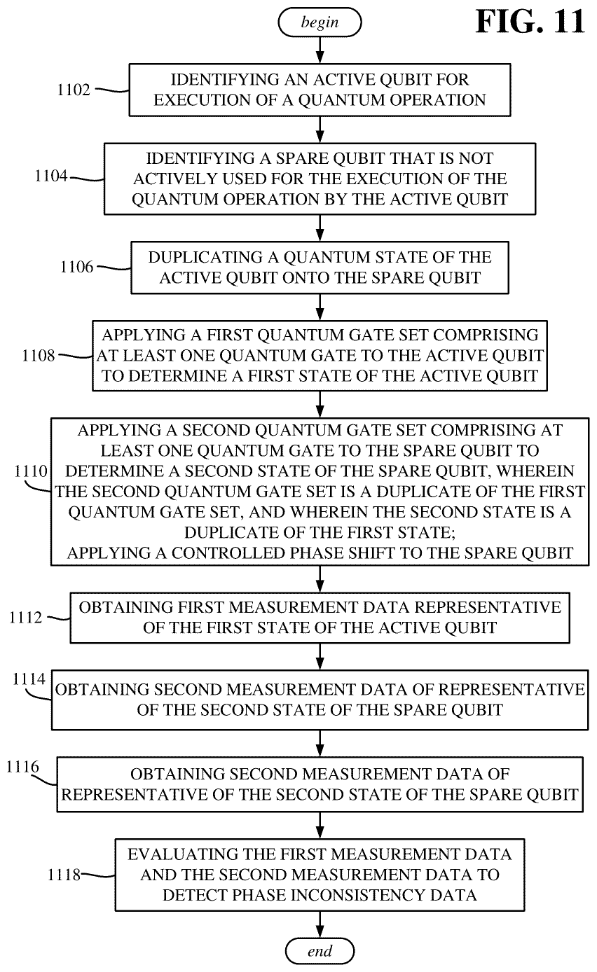

One or more concepts described herein can be embodied in a system, such as represented in the example operations of FIG. 11, and for example can include at least one memory that stores computer executable components and/or operations, and at least one processor that executes computer executable components and/or operations stored in the memory. Example operations can include operation 1102, which represents identifying an active qubit for execution of a quantum operation. Example operation 1104 represents identifying a spare qubit that can be not actively used for the execution of the quantum operation by the active qubit. Example operation 1106 represents duplicating a quantum state of the active qubit onto the spare qubit. Example operation 1108 represents applying a first quantum gate set comprising at least one quantum gate to the active qubit to determine a first state of the active qubit. Example operation 1110 represents applying a second quantum gate set comprising at least one quantum gate to the spare qubit to determine a second state of the spare qubit, wherein the second quantum gate set can be a duplicate of the first quantum gate set, and wherein the second state can be a duplicate of the first state. Example operation 1112 represents applying a controlled phase shift to the spare qubit. Example operation 1114 represents obtaining first measurement data representative of the first state of the active qubit. Example operation 1116 represents obtaining second measurement data of representative of the second state of the spare qubit. Example operation 1118 represents evaluating the first measurement data and the second measurement data to detect phase inconsistency data.

The phase inconsistency data can be first phase inconsistency data, and further operations can include, in response to the first phase inconsistency data being determined not to satisfy a defined error difference threshold, determining a corrective phase shift based on the first phase inconsistency data, applying a corrective phase shift to the spare qubit, obtaining third measurement data representative of a third state of the active qubit, obtaining fourth measurement data representative of a fourth state of the spare qubit, and evaluating the third measurement data and the fourth measurement data to detect second phase inconsistency data.

The corrective phase shift can be a first corrective phase shift, and further operations can include, in response to the second phase inconsistency data being determined not to satisfy the defined error difference threshold, determining a second corrective phase shift based on the second phase inconsistency data, applying a second corrective phase shift to the spare qubit, obtaining fifth measurement data representative of a fifth state of the active qubit, obtaining sixth measurement data representative of a sixth state of the spare qubit, and evaluating the fifth measurement data and the sixth measurement data to detect third phase inconsistency data.

Further operations can include, in response to the phase inconsistency data being determined not to satisfy a defined error difference threshold, iteratively applying one or more corrective phase shifts to the spare qubit until one or more phase inconsistency data measurements corresponding to the one or more corrective phase shifts result in the phase inconsistency data satisfying the defined error difference threshold.

Further operations can include obtaining current environmental data of a quantum system in which the active qubit and the spare qubit can be deployed, and, after applying the second quantum gate set to the spare qubit, simulating quantum noise that represents one or more interactions of the current environmental data with the spare qubit.

Further operations can include determining state data of a quantum system in which the active qubit and the spare qubit can be deployed, based on: environmental data of the quantum system, the phase inconsistency data, and at least one of: phase shift data for the active qubit or phase shift data for the spare qubit, and taking at least one action, based on the state data of the quantum system, using a reinforcement learning model, wherein the taking of the at least one action can include at least one of: adjusting a first phase shift of the active qubit, adjusting a second phase shift of the spare qubit, or re-running at least one quantum operations to correct a potential error.

Further operations can include obtaining current telemetry data associated with a current time or time range, obtaining historical telemetry data associated with a previous time or time range prior to the current time or time range, and predicting, by a reinforcement learning model based on the current telemetry data and the historical telemetry data, a quantum state error associated with the active qubit.

As can be seen, the technology described herein leverages spare qubits to mirror the states of active qubits. The dynamic use of the spare qubits facilitates real-time detection of phase shift deviations, monitoring noise, and ensuring state integrity, and is performed without disrupting ongoing quantum operations. The digital twin system can incorporate reinforcement learning to intelligently adjust phase shifts based on real-time feedback. The reinforcement learning model operates using a Markov decision process for optimizing phase corrections and minimizing errors by learning from historical performance data.

Another benefit is the integration of telemetry data, such as external environmental data, to account for temperature fluctuations and electromagnetic interference into the error detection and correction mechanisms of the digital twin system. The digital system twin system can integrates predictive AI models such as long short-term memory and gated recurrent unit to forecast phase deviations in advance; such models analyze temporal dependencies in quantum operations, allowing the system to preemptively adjust operations before errors manifest, thereby minimizing the number of reruns (shots) performed.

In this way, the technology described herein overcomes many issues with existing solutions to verifying qubit measurements. Typical quantum programs use multiple measurements or “shots” due to noise, decoherence, and the stochastic nature of quantum states; the number of shots often grows exponentially with the number of qubits, reducing the potential advantage of quantum computing. Instead of suboptimal resource utilization when executing many quantum algorithms, in which there are often many qubits that are left idle and wasted, (especially on larger machines with higher qubit counts), the overall computational process is improved by the technology described herein of utilizing such spare qubits, which are valuable resources.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a quantum processing unit comprising an active qubit and a spare qubit;
a computing device comprising at least one processor; and
a digital twin framework configured to execute, at least in part, via the computing device, the digital twin framework coupled to the quantum processing unit, and configured to:
duplicate a first state of the active qubit to the spare qubit as the first state of the spare qubit;
apply a duplicate set of one or more quantum gates to the active qubit and the spare qubit, to transform the first state of the active qubit to a second state of the active qubit, and to transform the first state of the spare qubit to the second state of the spare qubit;
apply a controlled phase shift to the spare qubit to obtain a third state of the spare qubit;
measure first current state data of the active qubit;
measure second current state data of the spare qubit;
determine, based on the first current state data and the second current state data, whether phase deviation data between the active qubit and the spare qubit satisfies a defined error deviation threshold; and
in response to the phase deviation data satisfying the defined error deviation threshold:
determine a corrective phase shift based on the phase deviation data, and
apply the corrective phase shift to the spare qubit to obtain the third state of the spare qubit.

2. The system of claim 1, wherein the corrective phase shift is a first corrective phase shift, wherein the phase deviation data is first phase deviation data, and wherein the digital twin framework is further configured to:
after application of the first corrective phase shift:
measure third current state data of the active qubit, and
measure fourth current state data of the spare qubit;
determine, based on the third current state data and the fourth current state data, whether second phase deviation data between the active qubit and the spare qubit satisfies the defined deviation error threshold; and
in response to the second phase deviation data satisfying the defined deviation error threshold:
determine a second corrective phase shift based on the phase deviation data, and
apply the second phase shift to the spare qubit to obtain a fourth state of the spare qubit.

3. The system of claim 1, wherein the digital twin framework is further configured to iteratively apply one or more corrective phase shifts to the spare qubit until one or more phase inconsistency data measurements, corresponding to the one or more corrective phase shifts, result in the phase inconsistency data satisfying the defined error difference threshold.

4. The system of claim 1, wherein the telemetry data comprises environmental data of an environment associated with the quantum processing unit, and wherein the digital twin framework is further configured to simulate quantum noise associated with a quantum gate of the duplicate set of the one or more quantum gates.

5. The system of claim 1, wherein the digital twin framework is configured to invoke a prediction model set to predict a phase-related error associated with the quantum processing unit.

6. The system of claim 5, wherein the noise prediction model set comprises at least one of: a recurrent neural network, or a long short-term memory network based on the telemetry data and prior collected telemetry data.

7. The system of claim 1, wherein the digital twin framework is configured to invoke an adaptive correction model set to determine an amount of phase shift to apply as the corrective phase shift.

8. The system of claim 7, wherein the adaptive decision-making model set comprises a reinforcement learning model.

9. A method, comprising:
executing, by a system comprising at least one processor, an operation on an active qubit and a spare qubit of a quantum system;
applying, by the system, a controlled phase shift to the spare qubit;
obtaining, by the system, first measured phase shift data based on the operation as executed on the active qubit;
obtaining, by the system, second measured phase shift data based on the operation as executed on the spare qubit after the applying of the controlled phase shift to the spare qubit;
determining, by the system, phase deviation data between the first measured phase shift data and the second measured phase shift data;
determining, by the system, whether the phase deviation data satisfies a defined phase deviation error threshold; and
in response to the phase deviation data satisfying the defined phase deviation error threshold, applying, by the system, a corrective phase shift to the spare qubit.

10. The method of claim 9, further comprising obtaining, by the system, environmental data associated with the quantum system, and simulating, by the system based on the environmental data, quantum noise in the quantum system.

11. The method of claim 9, further comprising obtaining, by the system, an amount of the corrective phase shift from a model set of the system based on the phase deviation data, prior phase deviation data from before the phase deviation data was obtained, and prior corrective phase shift data representative of previous corrective phase shifts from before the corrective phase shift.

12. The method of claim 9, further comprising obtaining, by the system, current telemetry data and prior telemetry data associated with the quantum system, and predicting, by a model set of the system based on the current telemetry data and prior telemetry data, at least one phase-related error with respect to the active qubit.

13. The method of claim 9, wherein the operation is a first operation, wherein the phase deviation data is first phase deviation data, wherein the corrective phase shift is a first corrective phase shift, and further comprising, in response to the first phase deviation data not satisfying the defined phase deviation error threshold:
determining, by the system, a second corrective phase shift based on the first phase deviation data,
applying, by the system, the second corrective phase shift to the spare qubit,
executing, by the system, a second operation on the active qubit and the spare qubit,
obtaining, by the system, third measured phase shift data based on the second operation as executed on the active qubit,
obtaining, by the system, fourth measured phase shift data based on the second operation as executed on the spare qubit after the applying of the controlled phase shift to the spare qubit,
determining, by the system, second phase deviation data between the third measured phase shift data and the fourth measured phase shift data;
determining, by the system, whether the second phase deviation data satisfies the defined phase deviation error threshold; and
in response to the second phase deviation data satisfying the defined phase deviation error threshold, applying, by the system, a second corrective phase shift to the spare qubit.

14. A system, comprising:
at least one processor; and
at least one memory that stores executable instructions that, when executed by the at least one processor, facilitate performance of operations, the operations comprising:
identifying an active qubit for execution of a quantum operation;
identifying a spare qubit that is not actively used for the execution of the quantum operation by the active qubit;
duplicating a quantum state of the active qubit onto the spare qubit;
applying a first quantum gate set comprising at least one quantum gate to the active qubit to determine a first state of the active qubit;
applying a second quantum gate set comprising at least one quantum gate to the spare qubit to determine a second state of the spare qubit, wherein the second quantum gate set is a duplicate of the first quantum gate set, and wherein the second state is a duplicate of the first state;
applying a controlled phase shift to the spare qubit;
obtaining first measurement data representative of the first state of the active qubit;
obtaining second measurement data of representative of the second state of the spare qubit; and
evaluating the first measurement data and the second measurement data to detect phase inconsistency data.

15. The system of claim 14, wherein the phase inconsistency data is first phase inconsistency data, and wherein the operations further comprise, in response to the first phase inconsistency data being determined not to satisfy a defined error difference threshold, determining a corrective phase shift based on the first phase inconsistency data, applying a corrective phase shift to the spare qubit, obtaining third measurement data representative of a third state of the active qubit, obtaining fourth measurement data representative of a fourth state of the spare qubit, and evaluating the third measurement data and the fourth measurement data to detect second phase inconsistency data.

16. The system of claim 15, wherein the corrective phase shift is a first corrective phase shift, and wherein the operations further comprise, in response to the second phase inconsistency data being determined not to satisfy the defined error difference threshold, determining a second corrective phase shift based on the second phase inconsistency data, applying a second corrective phase shift to the spare qubit, obtaining fifth measurement data representative of a fifth state of the active qubit, obtaining sixth measurement data representative of a sixth state of the spare qubit, and evaluating the fifth measurement data and the sixth measurement data to detect third phase inconsistency data.

17. The system of claim 15, wherein the operations further comprise, in response to the phase inconsistency data being determined not to satisfy a defined error difference threshold, iteratively applying one or more corrective phase shifts to the spare qubit until one or more phase inconsistency data measurements corresponding to the one or more corrective phase shifts result in the phase inconsistency data satisfying the defined error difference threshold.

18. The system of claim 15, wherein the operations further comprise obtaining current environmental data of a quantum system in which the active qubit and the spare qubit are deployed, and, after applying the second quantum gate set to the spare qubit, simulating quantum noise that represents one or more interactions of the current environmental data with the spare qubit.

19. The system of claim 15, wherein the operations further comprise determining state data of a quantum system in which the active qubit and the spare qubit are deployed, based on: environmental data of the quantum system, the phase inconsistency data, and at least one of: phase shift data for the active qubit or phase shift data for the spare qubit, and taking at least one action, based on the state data of the quantum system, using a reinforcement learning model, wherein the taking of the at least one action comprises at least one of: adjusting a first phase shift of the active qubit, adjusting a second phase shift of the spare qubit, or re-running at least one quantum operations to correct a potential error.

20. The system of claim 15, wherein the operations further comprise obtaining current telemetry data associated with a current time or time range, obtaining historical telemetry data associated with a previous time or time range prior to the current time or time range, and predicting, by a reinforcement learning model based on the current telemetry data and the historical telemetry data, a quantum state error associated with the active qubit.
